(19) United States
(12) Patent Application Publication
(10) Pub. No.: US 2024/0340533 A1
(43) Pub. Date: Oct. 10, 2024

(54) FOCUSING METHOD, FOCUSING DEVICE, AND UNMANNED AERIAL VEHICLE

(71) Applicant: AUTEL ROBOTICS CO., LTD., Nanshan Dist., Shenzhen (CN)

(72) Inventor: Zhaozao LI, Shenzhen, Guangdong (CN)

(21) Appl. No.: 18/535,405

(22) Filed: Dec. 11, 2023

Related U.S. Application Data
(63) Continuation of application No. PCT/CN2020/209611, filed on Jun. 2, 2022.

(30) Foreign Application Priority Data
Jun. 11, 2021 (CN) 202110653876.6

(51) Int. Cl. H04N 23/67; B64U 20/70; B64U 101/30

(52) U.S. Cl. CPC H04N 23/675; B64U 20/70; B64U 2101/30

(57) ABSTRACT

The present application discloses a focusing method, a focusing device, and an unmanned aerial vehicle. The focusing method is applied to the unmanned aerial vehicle on which an aerial camera is provided, if the unmanned aerial vehicle is at a high altitude, obtaining an far focus of the aerial camera, and obtaining a preset focus interval according to the far focus, wherein the minimum value of the preset focus interval is less than the far focus and the maximum value of the preset focus interval is greater than or equal to the far focus; and if the current image site of the aerial camera is greater than the maximum value or the current image site is less than the minimum value, then obtaining a first sharpness statistical value at the end of the last focusing, and determining whether to perform focus according to the first sharpness statistical value.

### CROSS-REFERENCE TO RELATED APPLICATIONS

The present application is a continuation of International Application No. PCT/CN2022/096911, filed Jun. 2, 2022, which claims priority to and the benefit of Chinese patent application No. 2021106538766, filed Jun. 11, 2021, the entireties of which are hereby incorporated herein by reference.

### BACKGROUND

Aircraft, such as Unmanned Aerial Vehicle (UAV), also known as unmanned airborne vehicles, are now being used more and more widely. Unmanned airborne vehicles have the advantages of small size, light weight, flexible mobility, fast response, unmanned, and low operating requirements. An unmanned airborne vehicle carries an aerial camera through a gimbal, which can also achieve functions of real-time image transmission and high-risk area detection, thereby offering a powerful supplement to satellite remote sensing and traditional aerial remote sensing. In recent years, unmanned airborne vehicles have a wide application prospect in disaster investigation and rescue, air monitoring, electricity transmission route patrol, aerial photography, aerial surveying, and military fields.

When an unmanned aerial vehicle performs aerial photography at high altitude, it is generally necessary to perform a focusing operation. For example, when the unmanned aerial vehicle changes in altitude to cause the image to become blurred, it is necessary to perform refocusing so that the image becomes clear from the blur. Also, in the prior art, the focusing operation is generally performed whenever there is a change in the image scene taken by the unmanned aerial vehicle.

However, with the above-mentioned prior art, on the one hand, frequent zooming may occur, and on the other hand, when the scene of the image taken by the unmanned aerial vehicle changes, there may be a case where the sharpness of the image remains unchanged. But in this case, focusing will also be performed, and both of the above-mentioned aspects may accelerate the loss of elements in the unmanned aerial vehicle.

### SUMMARY

The present application relates to the technical field of aircraft, particularly to a focusing method, a focusing device, and an unmanned aerial vehicle.

Embodiments of the present disclosure are intended to provide a focusing method, a focusing device, and an unmanned aerial vehicle that can reduce the frequencies at which the unmanned aerial vehicle focuses to extend the service lin response to e of elements in the unmanned aerial vehicles.
according to the first aspect, the present disclosure provides a focusing method applied to an unmanned aerial vehicle on which an aerial camera is provided, the method comprising:
in response to the unmanned aerial vehicle is at a high altitude, acquiring an far focus of the aerial camera;
obtaining a preset focus interval according to the far focus, wherein a minimum value of the preset focus interval is less than the far focus, and a maximum value of the preset focus interval is greater than or equal to the far focus; and
in response to the current image site of the aerial camera is greater than the maximum value, or the current image site is less than the minimum value, acquiring a first sharpness statistical value when a last focusing ends, and determining whether to perform focus according to the first sharpness statistical value.

According to the second aspect, an embodiment of the present disclosure provides a focusing device applied to an unmanned aerial vehicle on which an aerial camera is provided, wherein the device comprises:
a first acquisition unit for acquiring an far focus of the aerial camera in response to the unmanned aerial vehicle is at a high altitude;
a second acquisition unit for obtaining a preset focus interval according to the far focus, wherein a minimum value of the preset focus interval is less than the far focus, and a maximum value of the preset focus interval is greater than or equal to the far focus; and
a determination unit for, in response to a current image site of the aerial camera is greater than the maximum value, or the current image site is less than the minimum value, acquiring a first sharpness statistical value when a last focusing ends, and determining whether to focus according to the first sharpness statistical value.

According to the third aspect, an embodiment of the present disclosure provides an unmanned aerial vehicle, comprising:
a fuselage;
an engine arm connected to the fuselage;
a power device provided to the engine arm, the power device being configured to provide flying power to the unmanned aerial vehicle;
a gimbal connected to the fuselage;
an aerial camera being loaded on the unmanned aerial vehicle via the gimbal; and
at least one processor and a memory connected in communication with at least one processor, wherein the memory stores an instruction executable by at least one processor, the instruction being executed by at least one processor to enable at least one processor to execute the method mentioned above.

In an alternative mode, the unmanned aerial vehicle further comprises:
a radar sensor mounted to the fuselage, and a vision sensor loaded on the unmanned aerial vehicle via the gimbal;
wherein the radar is configured for detecting a distance from the unmanned aerial vehicle to the ground; and
the vision sensor is configured for detecting the distance between the unmanned aerial vehicle and an obstacle in front of the unmanned aerial vehicle.

According to the fourth aspect, an embodiment of the present application provides a non-volatile computer-readable storage medium, wherein the computer-readable storage medium stores computer-executable instructions that, when executed by an unmanned aerial vehicle, cause the unmanned aerial vehicle to execute the method mentioned above.

The beneficial effects of the embodiments of the present application are as follows. The focusing method provided by the present application is applied to unmanned aerial vehicles, and an aerial camera is provided on the unmanned aerial vehicle. The method includes, in response to the unmanned aerial vehicle is at a high altitude, acquiring an far focus of the aerial camera, and obtaining a preset focus interval according to the far focus, wherein the minimum value of the preset focus interval is less than the far focus and the maximum value of the preset focus interval is greater than or equal to the far focus; and in response to the current image site of the aerial camera is greater than the maximum value or the current image site is less than the minimum value, then acquiring a first sharpness statistical value at the end of the last focusing, and determining whether to perform focus according to the first sharpness statistical value. Therefore, only when the current image site and the preset focus interval meet the above two conditions, it is considered that the image may have become blurry, and further determination will be made whether to perform focus instead of frequent focusing. Compared with the prior art, the frequencies at which the unmanned aerial vehicle focuses can be reduced so as to extend the service lin response to e of elements in the unmanned aerial vehicle.

### BRIEF DESCRIPTION OF THE DRAWINGS

One or more embodiments are exemplified by the drawings in the accompanying drawings corresponding thereto. These exemplified descriptions do not constitute a limitation on the embodiments. Elements in the drawings having the same reference number designations are illustrated as similar elements, and unless otherwise particularly stated, the drawings do not constitute a proportional limitation.

FIG. 1 is a schematic diagram of an application scenario according to an embodiment of the present disclosure;

FIG. 2 is a flowchart of a focusing method provided in an embodiment of the present disclosure.

FIG. 3 is a schematic diagram of an far focus and a near focus of a lens provided in an embodiment of the present disclosure;

FIG. 4 is a schematic diagram of a preset focus interval, a current image site, an far focus and a near focus of a lens provided in an embodiment of the present disclosure;

FIG. 5 is a schematic structural diagram of a focusing device provided in an embodiment of the disclosure; and

FIG. 6 is a schematic structural diagram of an unmanned aerial vehicle provided in an embodiment of the disclosure.

### DETAILED DESCRIPTION

In order to make the purposes, technical solutions, and advantages of the embodiments of the present application clearer, the technical solutions in the embodiments of the present application will be clearly and completely described below in conjunction with the accompanying drawings in the embodiments of the present application. Obviously, the described embodiments are a part of the embodiments of the present application, rather than all the embodiments. Based on the embodiments of the present application, all other embodiments obtained by one of ordinary skills in the art without involving any inventive effort are within the scope of the present application.

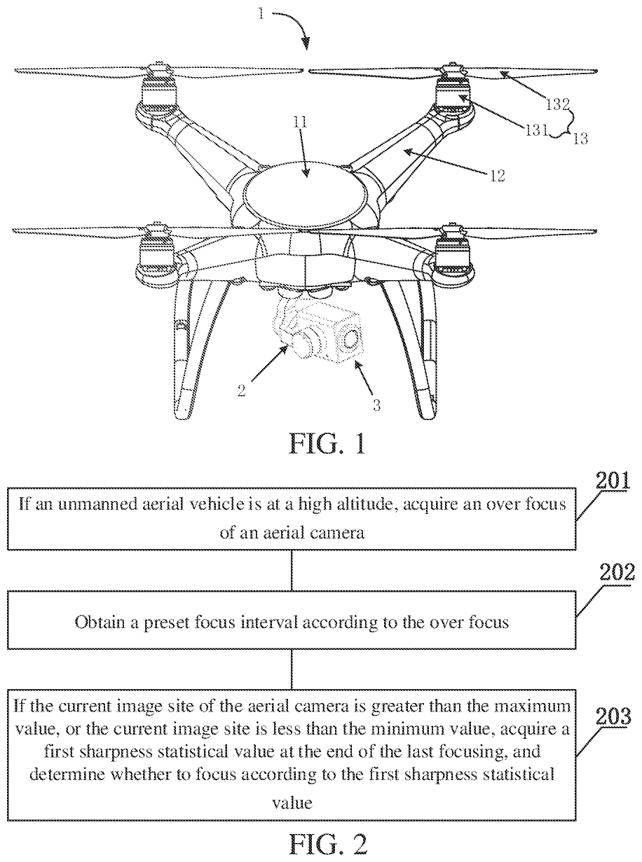

With reference to FIG. 1, FIG. 1 is a schematic diagram of an application scenario provided in an embodiment of the present disclosure. As shown in FIG. 1, the application scenario comprises an unmanned aerial vehicle 1, a gimbal 2, and an aerial camera 3. The aerial camera 3 is mounted to the unmanned aerial vehicle 1 via the gimbal 2 so as to perform photographing, video recording, etc.

Specifically, the unmanned aerial vehicle 1 comprises a fuselage 11, arms 12 connected to the fuselage 11, and a power device 13 on each arm 12 for providing flying power to the unmanned aerial vehicle 1. The power device 13 includes a motor 131 (e.g. a brushless motor) and a propeller 132 connected to the motor 131. The illustrated unmanned aerial vehicle 1 is a quadrotor unmanned aerial vehicle and the number of power device 13 in is four. In other possible embodiments, the unmanned aerial vehicle 1 may also be a three-rotor unmanned aerial vehicle, a six-rotor unmanned aerial vehicle, etc.

The gimbal 2 is configured for realizing the fixation of the aerial camera 3, or for randomly adjusting the attitude of the aerial camera 3 (for example, changing the shooting direction of the aerial camera 3) and keeping the aerial camera 3 stably in a set attitude. The gimbal 2 comprises a base, a motor, and a motor controller; the base is fixedly connected or detachably connected to the unmanned aerial vehicle 1 for mounting the aerial camera 3 to the unmanned aerial vehicle 1; and the motor is mounted to the base and connected to the aerial camera 3, and the motor controller is electrically connected to the motor for controlling the motor. The gimbal 2 can be a multi-shaft gimbal, with which the motors are adapted to be plurality, namely, one motor is provided for each shaft.

On the one hand, a plurality of motors can drive the aerial camera 3 to rotate so as to satisfy the adjustment of different shooting directions of the aerial camera 3, and the function of omnibearing scanning and monitoring can be achieved by manually and remotely controlling the rotation of the motors or using a program to make the motors rotate automatically. On the other hand, when the unmanned aerial vehicle 1 is performing aerial photography, the disturbance of the aerial camera 3 is cancelled by the rotation of the motor in real time, so that the aerial camera is prevented from shaking and the stability of the photographed picture is ensured.

A radar sensor, such as an ultrasonic sensor, is provided underneath the fuselage 11, and the ultrasonic sensor can be used to detect the distance between the UAV 1 and the ground. The ultrasonic sensor uses a special acoustic wave transmitter to realize the alternate transmission and reception of acoustic waves. The ultrasonic wave transmitted by the transmitter is reflected by an object (for example, the ground) and then received again by the transmitter. After the acoustic wave is transmitted, the ultrasonic sensor will switch to the receiving mode. The time elapsed between the transmission and reception is proportional to the distance between the object and the sensor, and the distance between the unmanned aerial vehicle 1 and the ground can be obtained by calculating the time elapsed between the transmission and reception.

The aerial camera 3 comprises a camera housing and a camera connected to the camera housing, and a gimbal connector is provided on the camera housing for connecting to the gimbal 2. A vision sensor, such as a binocular camera sensor, is further mounted to the camera housing, and the binocular camera sensor is configured to obtain the actual distance between the object to be photographed and the depth camera; when the object to be photographed is located in front of the unmanned aerial vehicle 1, the binocular camera sensor is configured to detect the distance between the unmanned aerial vehicle 1 and an obstacle in front of the unmanned aerial vehicle 1; and specifically, two cameras are configured to shoot the same scene at the same time, and corresponding image points of the same scene on two views are matched through various matching algorithms so as to obtain a disparity map, and then depth information about an imaging point can be calculated, that is, the distance between the imaging point and the plane on which the lens of the binocular camera sensor is located.

Based on the above description, the following will further elaborate on the embodiments of the present invention in conjunction with the accompanying drawings.

As shown in FIG. 2, there is a flowchart of a focusing method provided by an embodiment of the present application. The method is applied to an unmanned aerial vehicle, and an aerial camera is provided on the unmanned flying device, for example, the unmanned aerial vehicle 1 shown in FIG. 1. The steps of the method include:

201: in response to the unmanned aerial vehicle is at a high altitude, obtaining an far focus of the aerial camera.

In an embodiment, a determination also needs to be made first as to whether the unmanned aerial vehicle is at high altitude. Specifically, a radar sensor and a visual sensor may be installed on the unmanned aerial vehicle to determine whether the unmanned aerial vehicle is at a high altitude. The radar sensor and the vision sensor may be mounted to the unmanned aerial vehicle in the manner shown in FIG. 1.

In practice, during the flight of unmanned aerial vehicles, the radar sensor is capable of detect the first distance between the unmanned aerial vehicle and the ground in real time, while the visual sensor can detect the second distance between obstacles located in front of the unmanned aerial vehicle in real time. When the first distance is greater than the first preset distance and the second distance is greater than the second preset distance, it is determined that the unmanned aerial vehicle is at a high altitude. For example, in an embodiment, the first preset distance may be set as 5 meters and the second preset distance may be set as 8 meters. Then the unmanned aerial vehicle is determined to be at a high altitude at the time only when the radar sensor detects that it is greater than 5 meters from the ground to the radar sensor and the vision sensor detects that the distance of the obstacle ahead is greater than 8 meters (in other words, it can also be the scenario that the maximum distance that the vision sensor can detect is greater than 8 meters).

Conversely, as long as the first distance is less than the first preset distance or the second distance is less than the second preset distance, it is determined that the unmanned aerial vehicle is not at high altitude (i.e. at low altitude) at that time.

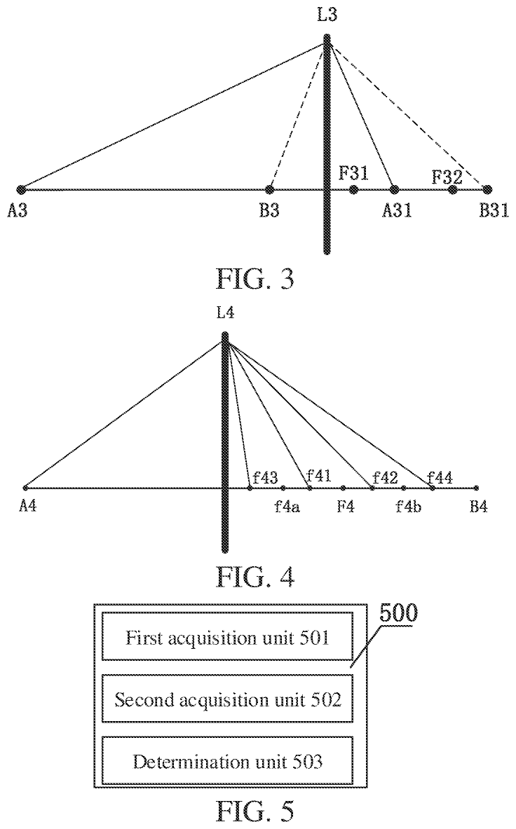

Then, after determining that the unmanned aerial vehicle is at a high altitude, the far focus of the aerial camera needs to be acquired. It is well known that every scenery in front of a lens on an aerial camera has one clear projection point (also called image site) inside the lens. As shown in FIG. 3, L3 represents the lens of an aerial camera; A3 represents a distant-view real object, i.e. a scenery distant from the lens; B3 represents a close-up view real object, i.e. a scenery close to the lens; A31 represents the image site of the distant-view real object A3 within the lens L3; B31 represents the image site of the close-up view real object B3 within the lens L3; F31 represents the far focus of the lens L3; and F32 represents the near focus of the lens L3. As the distant-view real object A3 moves farther away from the lens L3, i.e. the distant-view is that A3 moves to the left, the image site A3 moves closer to the lens; and the farther away the distant-view real object A3 is from the lens L3, the slower the image site A3 moves, and finally approaches the far focus F31 infinitely. In practical applications, when the distance between the distant-view real object A3 and the lens L3 exceeds a certain distance, the deviation between the image site A31 and the far focus F31 is small; and when the deviation between the image site A31 and the far focus F31 is less than the error of the lens mechanical movement, then it can be considered that the image site A31 and the far focus F31 coincide at this time. Furthermore, when the image site A31 coincides with the far focus F31, the statistical value of the detected sharpness is relatively large. At this time, the projection of the distant-view real object A3 in the lens L3 is relatively clear.

Therefore, the far focus of the lens can be obtained in the manner described above. Taking FIG. 3 as an example, a distant-view real object A3 is set, a lens L3 is moved left and right, and the image site and the statistical value of the sharpness corresponding to the distant-view real object A3 are continuously recorded during the movement of the lens L3. When the statistical value of the sharpness reaches a large value and the statistical value of the sharpness changes little during the process of moving the lens L3, it can be considered that at this moment, the projection of the distant-view real object A3 in the lens L3 is relatively clear, that is to say, it can be considered that the image site corresponding to the distant-view real object A3 substantially coincides with the far focus F31, and the far focus is correspondingly acquired by acquiring the image site.

It needs to be noted that, in the present embodiment, the statistical value of the sharpness refers to a statistical value obtained by image FIR filtering or IIR filtering, and the statistical value of the sharpness can reflect whether the image is clear. However, in other embodiments, other indicators may be selected as long as the indicators can indirectly or directly reflect whether the image is clear. The FIR (Finite Impulse Response) filter is a finite-length unit impulse response filter, and also called a non-recursive filter, which is the most basic element in a digital signal processing system, and it can guarantee arbitrary amplitude-frequency characteristics while having strict linear phase-frequency characteristics. The IIR filter adopts a recursive structure, i.e. a structure with a feedback loop. The operational structure of the IIR filter is generally composed of basic operations such as delay, multiplication by a coefficient, and addition, and can be combined into four types of structures, i.e. direct, positive quasi, cascaded, and parallel.

202: obtaining a preset focus interval according to the far focus.

When an unmanned aerial vehicle is at a high altitude, the lens usually teleforcus Then, when it is detected that the unmanned aerial vehicle is at a high altitude, in response to it is detected that the lens is currently focusing far, the focusing is not performed again, so as to prevent the image from being blurred.

At the same time, when the lens is focusing far, at this time, the image site of the distant-view real object in front of the lens in the lens should be within the interval including the over focus point. Therefore, a preset focus interval needs to be acquired according to the far focus point.

Wherein the minimum value of the preset focus interval is less than the far focus, and the maximum value of the preset focus interval is greater than or equal to the far focus. It can be seen that as long as the image site of the distant-view real object in front of the lens in the lens falls within the preset focus range, it can be considered that the lens focuses far at this moment, and the focusing operation may not be performed, so that the focusing frequency of the unmanned aerial vehicle at high altitude can be reduced under the condition that the captured image is clear, which not only extends the service life of the elements in the unmanned aerial vehicle, but also improves the user experience.

It can be understood that, the smaller the preset focus interval is set, the lower the probability, that the image site of the distant-view real object in front of the lens in the lens falls within the preset focus interval, is, and the higher the frequency of the unmanned aerial vehicle focuses at high altitude. Conversely, the larger the preset focus interval is set, the higher the probability, that the image site of the distant-view real object in front of the lens in the lens falls within the preset focus interval, is, and the lower the frequency of the unmanned aerial vehicle focuses at high altitude. It needs to be noted that in practical applications, in response to the preset focus interval is set too large, it may lead to the phenomenon of capturing blurry images without focusing. In practical applications, it is usually necessary to set the maximum value of the preset focus interval to be less than the near focus.

203: in response to the current image site of the aerial camera is greater than the maximum value, or the current image site is less than the minimum value, acquiring a first sharpness statistical value at the end of the last focusing, and determining whether to perform focus according to the first sharpness statistical value.

In an alternative implementation mode, reference is made to FIG. 4, L4 represents the lens of an aerial camera. A4 represents a distant-view real object captured by an unmanned aerial vehicle during an actual shooting process; F4 represents the far focus on the lens L4; B4 represents the near focus on the lens L4; f4a is the minimum value of the preset focus interval; f4b is the maximum value of the preset focus interval; and f41, f42, f43, and f44 are four possible existing current image sites.

It can be seen that when (f4a, f4b) is a preset focus interval, the minimum value f4a of the preset focus interval is less than the far focus F4, and the maximum value f4b of the preset focus interval is greater than or equal to the far focus F4 and less than the near focus B4. Therefore, based on the four possible image sites, it can be divided into the following two cases to determine whether to perform focus, and the two cases are for the case where the unmanned aerial vehicle is at a high altitude.

In the first case, when the current image site is f41 or f42, at this time, whether f41 or f42, the current image sites are within the preset focus interval (f4a, f4b), namely, the current image site is less than or equal to the maximum value of the preset focus interval and is greater than or equal to the minimum value of the preset focus interval. In this case, it can be considered that the lens of the aerial camera is focusing far at the moment. In practical applications, when the unmanned aerial vehicle is at a high altitude, an far focus is usually used. In this case, no focusing operation is needed such that the focusing frequencies can be reduced and the user experience can be improved. That is, in response to the current image site is less than or equal to the maximum value and the current image site is greater than or equal to the minimum value, it is determined that focusing is not performed.

In the second case, when the current image site is f43 or f44, neither f43 nor f44 is in the range of the preset focus interval (f4a, f4b). Namely, the current image site is greater than the maximum value of the preset focus interval or is less than the minimum value of the preset focus interval. That is, f43 is less than the minimum value f4a of the preset focus interval, and f44 is greater than the maximum value f4b of the preset focus interval. At this time, it can be considered that the lens of the aerial camera is not focusing far. At this time, it is necessary to first obtain the first sharpness statistical value at the end of the last focusing, and then it is determined whether to focus according to the first sharpness statistical value. That is to say, there will be no focusing operation between the end of the last focusing and the confirmation of whether to focus this time

Alternatively, the specific implementation process of determining whether to focus according to the first sharpness statistical value is: firstly, acquiring the current sharpness statistical value (denoted as FV1) corresponding to the current image site, and then calculating the absolute value of the difference value between the current sharpness statistical value and the first sharpness statistical value (denoted as FV0), namely, the absolute value being |FV1−FV0|, and then it being possible to determine whether to perform focus according to the absolute value.

In an embodiment, after obtaining the absolute value |FV1−FV0|, in response to it is determined that the absolute value is greater than the first preset threshold T1, it is determined to perform focusing, and in response to it is determined that the absolute value is less than or equal to the first preset threshold, it is determined not to perform focusing. In other words, in response to |FV1−FV0|>T1, it indicates that the difference between the current sharpness statistical value and the sharpness statistical value at the end of last focusing is large, the image may become blurred, and focusing needs to be performed again; and in response to |FV1−FV0|<=T1, it indicates that the difference between the current sharpness statistical value and the sharpness statistical value at the end of the last focusing is small, the image may remain clear, and no focusing is required.

The first preset threshold T1 can be adjusted according to the actual applications, and is not limited herein. For example, in practical applications, the first preset threshold T1 may be set to be small in response to it is daytime, and it can be seen that the first preset threshold T1 is set to be large in response to it is nighttime due to the presence of the image noise interference factors.

In another embodiment, after each time the absolute value |FV1−FV0| is obtained, in response to the absolute value is greater than the second preset threshold T2, one is added to the count value, and it is determined whether the count value is equal to the predesigned numerical value, and in response to the count value is less than the predesigned numerical value, the process returns to the step of acquiring the first sharpness statistical value at the end of the last focusing in step 203. Then, a new absolute value may be obtained again, and it is determined again whether the new absolute value is greater than the second preset threshold T2, and in response to so, one is added to the count value again. The cycle proceeds as described above until the count value equals the predesigned numerical value, at which time focusing is determined and the count value is set as zero in preparation for the next counting.

However, in response to the absolute value is less than or equal to the second preset threshold T2, the step of acquiring the first sharpness statistical value at the end of the last focusing in step 203 is also returned to, and the focusing operation is not performed at this time. Further, it is also possible to obtain a new absolute value and determine again whether the new absolute value is greater than the second preset threshold T2, and in response to so, increase the count value by one again. The cycle is again performed as described above until the count value equals the predesigned numerical value, at which time focusing is determined and the count value is set as zero.

For example, assuming that the predesigned numerical value is 5, it is determined that the focusing operation is performed only in response to |FV1−FV0|>T2 is obtained 5 times in succession.

In this embodiment, it is not only restricted that focusing takes place only after the |FV1−FV0| is greater than the second preset threshold T2, but it is further restricted that focusing takes place only when the number of times of |FV1−FV0|>T2 is greater than a predesigned numerical value. Then, even if the lens moves or the image is adjusted before the count value reaches the count value, no focusing operation is performed, thus further preventing the phenomenon of frequent focusing operations.

In an alternative mode, the unmanned aerial vehicle being further provided with a radar sensor and a visual sensor, and the method further comprising:
obtaining a first distance from the unmanned airborne vehicle to the ground via the radar sensor;
acquiring, by the vision sensor, a second distance between the unmanned aerial vehicle and an obstacle in front of the unmanned aerial vehicle; and
in response to the first distance is greater than a first preset distance and the second distance is greater than a second preset distance, determining that the unmanned aerial vehicle is at a high altitude.

In an alternative mode, the method further comprises:
in response to the unmanned aerial vehicle is not at a high altitude, determining whether to perform focus according to the first sharpness statistical value.

In an alternative mode, the determining whether to perform focus according to the first sharpness statistical value comprises:
acquiring a current sharpness statistical value corresponding to the current image site;
calculating an absolute value of a din response to ference value between the current sharpness statistical value and the first sharpness statistical value; and
based on the absolute value, determining whether to perform focus.

In an alternative mode, based on the absolute value, determining whether to perform focus comprises:
in response to the absolute value is greater than a first preset threshold, determining to focus; and
in response to the absolute value is less than or equal to the first preset threshold, determining that focusing is not performed.

In an alternative mode, based on the absolute value, determining whether to perform focus comprises:
in response to the absolute value is greater than a second preset threshold, adding 1 to a count value;
judging whether the count value is equal to a predesigned numerical value; and
if not, returning to the step of acquiring a first sharpness statistical value when a last focusing ends; and
if so, determining to focus, and setting the count value as 0.

In an alternative mode, based on the absolute value, determining whether to perform focus further comprises:
in response to the absolute value is less than or equal to the second preset threshold, then returning to the step of acquiring a first sharpness statistical value when the last focusing ends.

In an alternative mode, the method further comprises:
in response to the current image site is less than or equal to the maximum value of the preset focus interval, and the current image site is greater than or equal to the minimum value of the preset focus interval,
determining not to focus.

In both cases, it is determined whether to perform focus when the unmanned aerial vehicle is at a high altitude. However, for the case where the unmanned aerial vehicle is at a low altitude, since in practical applications, when the unmanned aerial vehicle is in low altitude, it is possible to focus far or near when shooting, then whether to perform focus can be determined directly by the first sharpness statistical value and the current sharpness statistical value, i.e. whether to perform focus can be determined according to the absolute value |FV1−FV0J. The specific implementation process is similar to the above-mentioned embodiments, which is within the scope of easy understanding for a person skilled in the art and thus will not be described in detail herein.

In summary, it is first determined whether the unmanned aerial vehicle is at high or low altitudes by using the radar sensor and the vision sensor. Then, according to the fact that the unmanned aerial vehicle usually focuses far or near in practical applications, and combining the difference between the current sharpness statistical value and the first sharpness statistical value, the situation that the unmanned aerial vehicle needs to focus when it is at high altitude or at low altitude can be determined respectively. Therefore, it is possible to avoid the situation of frequent focusing as in the prior art, so as to extend the service life of elements in an unmanned aerial vehicle, and also to ensure that the image captured by the aerial camera is a clear image, resulting in a good experience for users.

FIG. 5 is a schematic structural diagram of a focusing device provided in an embodiment of the present invention. As shown in FIG. 5, the focusing device 500 includes a first acquisition unit 501, a second acquisition unit 502, and a determination unit 503.

The first acquisition unit 501 is configured to acquire the far focus of the aerial camera in response to the unmanned aerial vehicle is at high altitude. The second acquisition unit 502 is configured to obtain a preset focus interval according to the far focus. The minimum value of the preset focus interval is less than the far focus, and the maximum value of the preset focus interval is greater than or equal to the far focus. The determination unit 503 is configured to, in response to the current image site is greater than the maximum value, or in response to the current image site is less than the minimum value, acquire the first sharpness statistical value at the end of the last focusing, and determine whether to perform focus according to the first sharpness statistical value.

Since the device embodiment and the method embodiment are based on the same concept, the contents of the device embodiments may refer to the method embodiments without the contents conflicting with each other, and the description thereof will not be repeated herein.

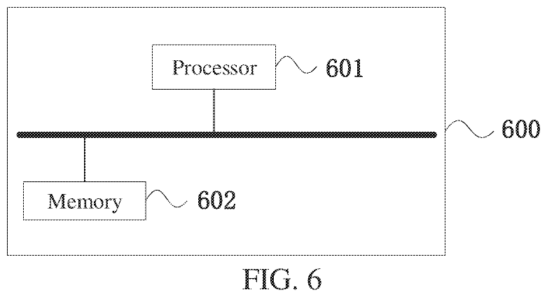

FIG. 6 is a schematic structural diagram of an unmanned aerial vehicle provided in an embodiment of the present invention. As shown in FIG. 6, the unmanned aerial vehicle 600 includes one or more processors 601 and a memory 602. One processor 601 is exemplified in FIG. 6.

The processor 601 and the memory 602 may be connected by a bus or in other ways. FIG. 6 takes a bus connection as an example.

The memory 602, as a non-volatile computer-readable storage medium, can be configured to store non-volatile software programs, and non-volatile computer-executable programs and modules, such as program instructions/modules (e.g. units in FIG. 5) corresponding to the focusing method in embodiments of the present invention. The processor 5021 executes various functional applications and data processing of unmanned aerial vehicles by running non-volatile software programs, instructions, and modules stored in memory 602, that is, the focusing method in the above method embodiments and the functions of various modules and units in the above device embodiments are implemented.

The memory 602 may include high-speed random access memory, as well as non-volatile memory, such as at least one disk memory device, flash memory device, or other non-volatile solid-state memory devices. In some embodiments, the memory 602 may optionally include a memory remotely provided relative to the processor 601. These remote memories can be connected to the processor 601 via a network. Examples of such networks include, but are not limited to, the Internet, Intranets, local area networks, mobile communication networks, and combinations thereof.

The program instructions/modules are stored in the memory 602, and the same are when executed by one or more processors 601, the focusing method in any of the above method embodiments is executed, for example, executing various steps shown in FIG. 2 described above. It is also possible to achieve the functions of each unit as described in FIG. 5.

The embodiments of the present invention also provide a non-volatile computer-readable storage medium, which stores computer-executable instructions. When the computer-executable instructions are executed by the unmanned aerial vehicle, the unmanned aerial vehicle executes the method of any of the embodiments.

An embodiment of the invention further provides a computer program product including a computer program stored on a computer-readable storage medium. The computer program includes program instructions which, when executed by a computer, cause the computer to execute the method of any of the embodiments.

Finally, it should be noted that: the above embodiments are merely illustrative of the technical solutions of the present application, rather than limiting it; combinations of technical features in the above embodiments or in different embodiments are also possible under the idea of the present application, and the steps can be implemented in any order; there are many other variations of the different aspects of the present application as described above, which are not provided in detail for the sake of brevity; although the present application has been described in detail with reference to the foregoing embodiments, those of ordinary skills in the art will appreciate that the technical solutions disclosed in the above-mentioned embodiments can still be modified, or some of the technical features thereof can be replaced by equivalents; such modifications or replacements do not depart the essence of the corresponding technical solution from the scope of the technical solutions of embodiments of the present application.

1. A focusing method being applied to an unmanned aerial vehicle, the unmanned aerial vehicle being provided with an aerial camera, the method comprising:
obtaining an far focus of the aerial camera, in response to the unmanned aerial vehicle is at a high altitude;
obtaining a preset focus interval according to the far focus, wherein a minimum value of the preset focus interval is less than the far focus, and a maximum value of the preset focus interval is greater than or equal to the far focus; and
in response to a current image site of the aerial camera is greater than the maximum value, or the current image site is less than the minimum value, obtaining a first sharpness statistical value from a last focusing event, and determining whether to perform focus according to the first sharpness statistical value.

2. The focusing method according to claim 1, the method further comprising:
in response to the unmanned aerial vehicle is not at the high altitude, determining whether to perform focus according to the first sharpness statistical value.

3. The focusing method according to claim 1, wherein the determining whether to perform focus according to the first sharpness statistical value comprises:
acquiring a current sharpness statistical value corresponding to the current image site;
calculating an absolute value of a difference value between the current sharpness statistical value and the first sharpness statistical value; and
determining whether to perform focus based on the absolute value.

4. The focusing method according to claim 3, wherein the based on the absolute value, determining whether to perform focus comprises:
in response to the absolute value is greater than a first preset threshold, determining to perform focus; and
in response to the absolute value is less than or equal to the first preset threshold, determining that focusing is not performed.

5. The focusing method according to claim 3, wherein the based on the absolute value, determining whether to perform focus comprises:
in response to the absolute value is greater than a second preset threshold, adding 1 to a count value;
judging whether the count value is equal to a predesigned numerical value; and
in response to the count value is not equal to the predesigned numerical value, returning to a step of acquiring a first sharpness statistical value when a last focusing ends; and
in response to the count value is equal to the predesigned numerical value, determining to perform focus, and setting the count value as 0.

6. The focusing method according to claim 5, wherein the based on the absolute value, determining whether to perform focus further comprises:
in response to the absolute value is less than or equal to the second preset threshold, then returning to the step of acquiring a first sharpness statistical value when a last focusing ends.

7. The focusing method according to claim 1, wherein the method further comprises:
in response to the current image site is less than or equal to the maximum value of the preset focus interval, and the current image site is greater than or equal to the minimum value of the preset focus interval,
determining not to perform focus.

8. A focusing device applied to an unmanned aerial vehicle on which an aerial camera is provided, wherein the device comprises:
a first acquisition unit configured to obtain a far focus of the aerial camera in response to the unmanned aerial vehicle is at a high altitude;
a second acquisition unit configured to obtain a preset focus interval according to the far focus, wherein a minimum value of the preset focus interval is less than the far focus, and a maximum value of the preset focus interval is greater than or equal to the far focus; and
a determination unit is configured to, in response to a current image site of the aerial camera is greater than the maximum value, or the current image site is less than the minimum value, obtain a first sharpness statistical value when a last focusing ends, and determine whether to perform focus according to the first sharpness statistical value.

9. A focusing device according to claim 8, wherein the determination unit is further configured to:
in response to the unmanned aerial vehicle is not at the high altitude, determine whether to perform focus according to the first sharpness statistical value.

10. A focusing device according to claim 8, wherein the determine whether to perform focus according to the first sharpness statistical value comprises:
obtain a current sharpness statistical value corresponding to the current image site;
calculate an absolute value of a difference value between the current sharpness statistical value and the first sharpness statistical value; and
determine whether to perform focus based on the absolute value.

11. An unmanned aerial vehicle, comprising:
a fuselage;
an engine arm connected to the fuselage;
a power device provided to the engine arm, the power device being configured to provide flying power to the unmanned aerial vehicle;
a gimbal connected to the fuselage;
an aerial camera being loaded on the unmanned aerial vehicle via the gimbal; and
at least one processor and a memory connected in communication with the at least one processor, wherein the memory stores an instruction executable by the at least one processor, the instruction being executed by the at least one processor to enable the at least one processor to execute a focusing method, the focusing method comprises:
obtaining an far focus of the aerial camera, in response to the unmanned aerial vehicle is at a high altitude;
obtaining a preset focus interval according to the far focus, wherein a minimum value of the preset focus interval is less than the far focus, and a maximum value of the preset focus interval is greater than or equal to the far focus; and
in response to a current image site of the aerial camera is greater than the maximum value, or the current image site is less than the minimum value, obtaining a first sharpness statistical value from a last focusing event, and determining whether to perform focus according to the first sharpness statistical value.

12. The unmanned aerial vehicle according to claim 11, wherein the unmanned aerial vehicle further comprises:
a radar sensor mounted to the fuselage, and a vision sensor loaded on the unmanned aerial vehicle via the gimbal;
wherein the radar sensor is configured to detect a distance from the unmanned aerial vehicle to ground; and
the vision sensor is configured to detect a distance between the unmanned aerial vehicle and an obstacle in front of the unmanned aerial vehicle.

13. The unmanned aerial vehicle according to claim 11, wherein the focusing method further comprising:
in response to the unmanned aerial vehicle is not at the high altitude, determining whether to perform focus according to the first sharpness statistical value.

14. The unmanned aerial vehicle according to claim 11, wherein the focusing method further comprising,
acquiring a current sharpness statistical value corresponding to the current image site;
calculating an absolute value of a difference value between the current sharpness statistical value and the first sharpness statistical value; and
determining whether to perform focus based on the absolute value.

15. The unmanned aerial vehicle according to claim 14, wherein the focusing method further comprising:
in response to the absolute value is greater than a first preset threshold, determining to perform focus; and
in response to the absolute value is less than or equal to the first preset threshold, determining that focusing is not performed.

16. The unmanned aerial vehicle according to claim 14, wherein the focusing method further comprising:
in response to the absolute value is greater than a second preset threshold, adding 1 to a count value;
judging whether the count value is equal to a predesigned numerical value; and
in response to the count value is not equal to the predesigned numerical value, returning to a step of acquiring a first sharpness statistical value when a last focusing ends; and
in response to the count value is equal to the predesigned numerical value, determining to perform focus, and setting the count value as 0.

17. The unmanned aerial vehicle according to claim 14, wherein the focusing method further comprising:
in response to the absolute value is less than or equal to the second preset threshold, then returning to the step of acquiring a first sharpness statistical value when a last focusing ends.

18. The unmanned aerial vehicle according to claim 14, wherein the focusing method further comprising:
in response to the current image site is less than or equal to the maximum value of the preset focus interval, and the current image site is greater than or equal to the minimum value of the preset focus interval,
determining not to perform focus.
